(19) United States
(12) Patent Application Publication
(10) Pub. No.: US 2007/0063172 A1
(43) Pub. Date: Mar. 22, 2007

(54) Furnace and method for expanding material

(75) Inventors: Claude Samson, St-Antonin (CA); Sebastien Landry, Riviere-du-Loup (CA); Richard Girard, Olds (CA); Francois Desjardins, Mont-St-Hilaire (CA)

Correspondence Address: ST. ONGE STEWARD JOHNSTON & REENS, LLC, 986 BEDFORD STREET, STAMFORD, CT, 06905-5619, US

(73) Assignee: Premier Horticulture Ltee; Canada

(21) Appl. No.: 11/515,938

(22) Filed: Sep. 5, 2006

Related U.S. Application Data
(63) Continuation of application No. PCT/CA05/00324, filed on Mar. 2, 2005.

(30) Foreign Application Priority Data
Mar. 2, 2004 (CA) 2,458,935

(51) Int. Cl. C04B 14/00

(52) U.S. Cl. 252/378 P

(57) ABSTRACT

A furnace and a method for expanding an expandable material, such as perlite or vermiculite, comprising a thermally insulated enclosure and a conveyor for conveying the material within the enclosure, the conveyor having a contact surface made of a heat resistant material resistant to at least a predetermined temperature. The furnace also comprises a heating system for heating the contact surface to at least the predetermined temperature. The furnace further comprises feeding means for feeding the material on the contact surface to expand the material through thermal shock and obtain an expanded material. The furnace also comprises removing means for removing the expanded material from the enclosure.

### CROSS-REFERENCE TO RELATED APPLICATIONS

The present application is a continuation of pending International patent application PCT/CA2005/000324 filed on Mar. 2, 2005 which designates the United States and claims priority from Canadian patent application 2,458,935 filed on Mar. 2, 2004, the content of which is incorporated herein by reference.

### FIELD OF THE INVENTION

The present invention generally relates to the field of production of expanded perlite and vermiculite. These products are used in different applications such as filtration, horticulture, insulation and other fields.

### BACKGROUND OF THE INVENTION

Perlite and vermiculite are natural rocks of volcanic origin. The terms “perlite” and “vermiculite” are generic terms and not commercial names to designate this type of volcanic rock. Vermiculite resembles mica and belongs to the phyllosilicate mineral group.

The characteristic that distinguishes perlite and vermiculite from other volcanic stones is their capacity to expand in volume, in the order of 4 to 20 times their original volume, when they are heated up to a certain temperature. This expansion is due to the presence of 2 to 6% water in the raw perlite stone and of the order of 8 to 16% water for vermiculite.

When perlite is heated quickly to a temperature above 1600° F. (870° C.), the raw stone (mineral) bursts open in a manner similar to a grain of pop-corn, due to the evaporation of its water content. This reaction creates an infinity of small air bubbles in the stone, thus giving it a porous aspect and a slightly vitreous surface. This transformation of the mineral gives it its characteristic physical properties and its lightness.

The expansion of the vermiculite occurs in a slightly different manner since the mineral is made of fine lamellae glued one on the other, which is typical for mineral that resemble mica. During expansion, these lamellae swell while remaining stuck together. The expansion of vermiculite is similar to the pulling of an accordion.

Consequently, vermiculite expands along one single dimension while perlite expands in three dimensions.

Means for Expansion

The expansion of perlite and vermiculite occurs following an addition of heat done in a very particular manner. Moreover, it is necessary to remove the mineral particles at a very precise moment from the heat zone. The particles must be heated quickly to render them sufficiently malleable so that they can expand themselves under the effect of the water evaporation present in the mineral. This operation is done more efficiently in furnaces specially designed for this type of process.

Expanded Product

This expansion process gives also to the expanded perlite one of its distinctive characteristics, its white color. While the color of the mineral ranges from light to grey to glossy black, the color of the expanded perlite ranges between clear white and greying white.

The expansion of vermiculite can also be done through a chemical process, which is not the case for perlite.

Fields of Use of Expanded Perlite or Vermiculite

Expanded perlite or vermiculite can be manufactured into a density ranging between 2 lbs/ft³ and 15 lbs/ft³, which makes it a material adaptable to several applications, including filtration, horticulture, insulation as well as a multitude of other applications. This material can also be used as an inert transport agent or as a non-flammable material, among other things.

a. Industrial Applications

The industrial applications for expanded perlite are numerous, ranging as a high performance ingredient for plastics to cement for oil wells. Other applications include also its use as a filtration element in the pharmaceutical industry as well as the food chemical and municipal industries.

Additional applications include its use in abrasive soaps, cleaners and polishers, as well as a variety of uses in smelter industries because of its insulating properties and thermal resistance. This thermal resistance property is particularly advantageous when perlite is used in the production of firebrick, mortar and pipe insulation, among other things.

Vermiculite is used as an industrial absorbant, in textured paints, in reinforced fiberglass, and even brake discs.

b. Horticultural Applications

In horticulture, perlite is used throughout the world as a hydroponic component where its superior aeration and humidity retention properties are excellent for plants. Vermiculite, on the other hand, is known for its water retention capacity.

Perlite and vermiculite are particularly advantageous in horticultural applications given their pH neutrality, sterility and their capacity to inhibit the development of weeds. Perlite is also used as a transport agent for fertilizers, herbicides and pesticides, as well as in mixes for substrate cultures to increase their porosity.

c. Construction Applications

Given their insulation capacity and their weight, perlite and vermiculite are currently used to fill cavities in concrete block walls in various constructions. In addition to providing insulation, perlite reduces the transmission of noise and is resistant to vermin.

Perlite and vermiculite can also be used as an aggregate in Portland cement, in concrete, and gypsum for external applications and resistance to fire, as well as for the manufacturing of a light concrete compound.

### STATE OF THE PRIOR ART

The existing techniques for expansion of perlite and vermiculite usually consists of using a vertical furnace, as illustrated in FIG. 1, with a live flame in which the mineral is sent into the direction of the live flame 40 by a mineral feeding system 42. The furnace comprises an interior tube 54 and an external envelope with insulation or firebricks 56. When the mineral reaches a high temperature zone near the flame, its water content evaporates, creating a much lighter particle, which can be sucked away relatively easily. The expanded mineral is then directed towards the top by an ascending flow of hot air 44, created by a ventilation system 46.

The expanded perlite and the transport air flow are then directed towards a separation apparatus to recuperate the product. This apparatus is not illustrated in the attached Figures. The separation apparatus is generally a cyclone collector, a deduster or a decanting chamber. In fact, any particle separating system for air can be used for such an application.

The heat source comes from a burner generating several million BTU, with, as an energy source, gas or oil number 2. The burner 48 generally comprises a combustion ventilator 50 to which one adds compressed air 52 to obtain adequate combustion.

Although the present technology offers the advantage of using a basic technology applied to a know process in the field of perlite and vermiculite, the present technology offers several inconveniences.

Firstly, it is difficult to adjust the ascending air flow for the removal of the expanded material. Moreover, when the combustion burner is badly adjusted, the perlite becomes colored, especially in the case of oil burners. Vermiculite is less sensitive to this last problem because it initially has a tanned color.

The present expansion techniques have the additional disadvantage of generating high energy costs as well as high material maintenance costs.

U.S. Pat. No. 4,579,525 (ROSS) discloses a furnace having porous refractory surfaces arranged in a circular pattern for ease of introducing the expandable material into the furnace and for ease of removal of the expanded product from the furnace. The rotational speed of the refractory surfaces can be varied for accommodating different materials to be processed. The furnace comprises a feed system for feeding an air-combustible gas mixture. The gas mixture is allowed to flow through the porous refractory surface and burns on top of the refractory surface that enters into contact with the expandable material. Consequently, the expandable material is heated not only by conduction from the refractory surface, but also by convection of hot gases, products of the combustion flowing from the refractory surface to the expandable material. Unfortunately, heat is lost through the combustion process as the combustion gases are removed from the furnace

The present techniques are also limited by the weak energetic performance of burners with respect to the gas or oil enthalpy, as well as the necessity of incurring important capital costs for equipment. It is also difficult to automate the process. The dust produced by manipulation of the expanded material in the air intake system reduces also the efficiency of several present techniques. Finally, the high rate of loss of the final product decreases considerably the yield of the present techniques.

### SUMMARY OF THE INVENTION

One object of the present invention is to propose an apparatus and a process to produce expanded perlite or vermiculite, which solve several of the inconveniences associated with prior art furnaces.

More particularly, the present invention provides a furnace for expanding volcanic rocks that expand when heated at a predetermined thermal shock temperature, the furnace being characterized in that it comprises:

a thermally insulated enclosure;

a conveyor for conveying the volcanic rocks within the enclosure, the conveyor having a contact surface made of a heat resistant material resistant to at least said predetermined thermal shock temperature;

a heating system located inside the furnace for heating said contact surface to said predetermined thermal shock temperature;

feeding means for feeding the enclosure with the volcanic rocks to expand and for depositing said volcanic rocks on the contact surface;

removing means for removing the expanded volcanic rocks from the enclosure,

whereby, the volcanic rocks, at the touch of the contact surface, expands through thermal shock and produces the expanded volcanic rocks.

Preferably, the conveyor is any apparatus that conveys material, such as for example a continuously moving conveyor belt or a rotary plate.

Preferably, the heating system generates heat for heating the contact surface from any type of heat source, such as for example from electrical heat elements, or from contained combustion chambers fed with fuel such as natural gas or heating oil. Gases from the combustion chamber do not enter into contact with the expandable material.

Preferably, the heat resistant material is selected depending on the expandable material to be processed by the furnace. For example, if the material to be processed is vermiculite, the heat resistant material must be able to withstand heating temperatures around 600 to 700° C., the expansion temperature for vermiculite. Steel is an example of a heat resistant material to be used with vermiculite. If the material to be processed is perlite, the heat resistant material must be able to withstand heating temperatures around 1100 to 1200° C., the expansion temperature for perlite. Ceramics is an example of a heat resistant material to be used with perlite.

The present invention also provides a method for expanding volcanic rocks that expands when heated at a predetermined thermal shock temperature, said method comprising the steps of:

a) providing a thermally insulated enclosure;

b) conveying the volcanic rocks within the enclosure, the conveyor having a contact surface made of a heat resistant material resistant to at least said predetermined thermal shock temperature;

c) heating said contact surface to said predetermined thermal shock temperature;

d) depositing said volcanic rocks on the contact surface;

e) removing the expanded volcanic rocks from the enclosure,

whereby, the volcanic rocks, at the touch of the contact surface, expands through thermal shock and produces the expanded material.

A non-restrictive description of a preferred embodiment of the invention will now be given with reference to the appended drawings.

### BRIEF DESCRIPTION OF THE DRAWINGS

FIG. 1 is a cross-section schematic view of a model of a vertical furnace, as used in prior art.

FIG. 2 is a schematic top view of an expansion apparatus for perlite and vermiculite, according to a first preferred embodiment of the invention.

FIG. 3 is a schematic side view of the expansion apparatus shown in FIG. 2.

FIG. 4 is a cross-section schematic view, along the line IV-IV, of the expansion apparatus shown in FIG. 2.

FIG. 5 is a perspective view of the inside of the furnace shown in FIG. 2.

FIG. 6 is a schematic top view of an expansion apparatus for perlite and vermiculite, according to a second preferred embodiment of the invention.

FIG. 7 is a schematic side view of the expansion apparatus shown in FIG. 6.

FIG. 8 is a perspective view of the inside of the furnace shown in FIG. 6.

FIG. 9 is a perspective view of the outside of an expansion apparatus for perlite and vermiculite, according to a third preferred embodiment of the present invention.

FIG. 10 is a perspective view of the inside of the expansion apparatus shown in FIG. 9.

FIG. 11 is an exploded view of the expansion apparatus shown in FIG. 9.

FIG. 12 is a cross-section schematic view of the inside of the expansion apparatus shown in FIG. 9 along a horizontal plane.

FIG. 13 is a cross-section schematic view of the inside of the expansion apparatus shown in FIG. 9 along a vertical plane.

FIG. 14 is a detailed view of components shown in FIG. 13.

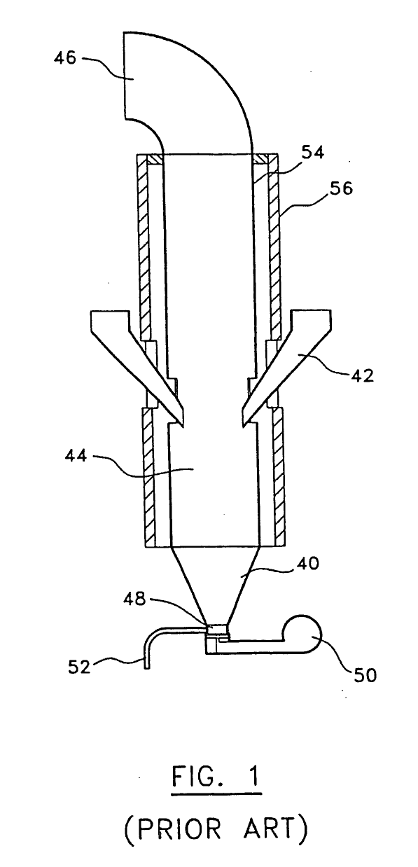

### DETAILED DESCRIPTION OF THE INVENTION

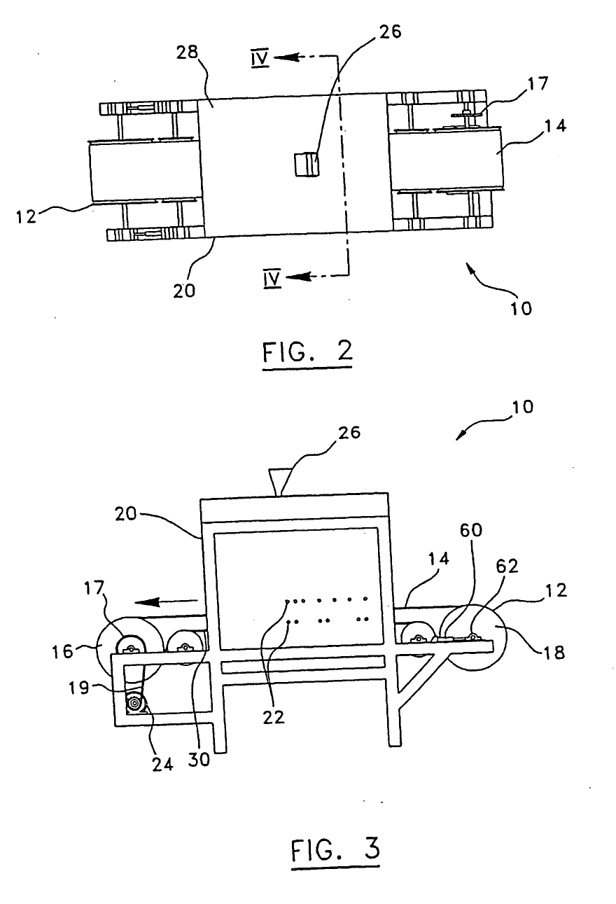

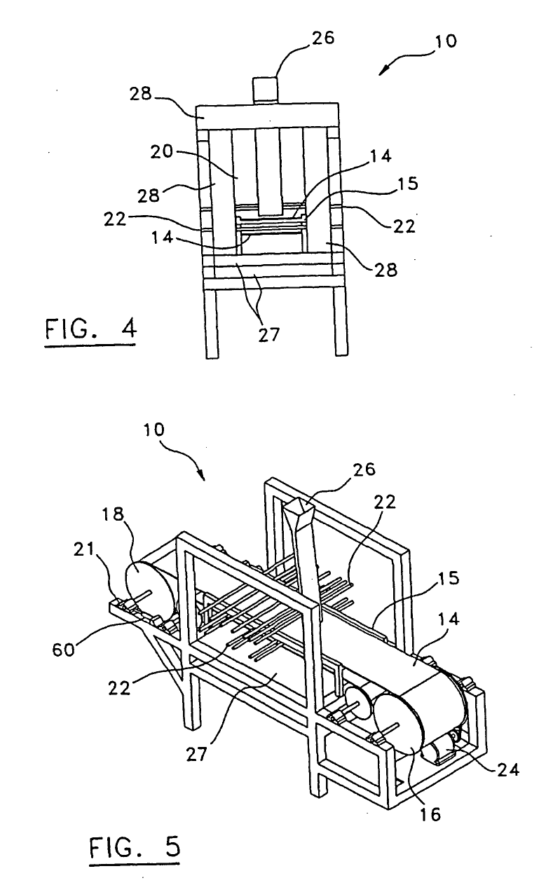

According to a first preferred embodiment shown in FIGS. 2 to 5, the expansion apparatus 10 comprises a conveyor belt 12 including a metallic belt 14 mounted on a driver roller 16 and an end roller 18. The belt 14 passes in a furnace 20 heated with electrical heating elements 22. The functional principle of the present invention is relatively simple. As shown in FIG. 4, the furnace 20 is also provided with an insulating material 27.

The metallic conveyor belt 14 is driven by the driver roller 16 and an electric motor 24. The belt 14 passes through the furnace 20 to be heated to the required temperature for expansion of the material. This belt 14 is designed to not let any material pass through it, while retaining heat. The belt moves through a guideway 15 in the shape of a trough to prevent the material from falling under the belt 14 during the expansion process. The heating elements 22 are positioned to provide a greater amount of heat to the belt 14 before the material is deposited on the belt from a feeding chute 26, placed above the belt 14. The heating elements 22 are principally placed ahead of the feeding chute 26 to ensure that a thermal shock is created when the material touches the metallic belt 14. The furnace 20 comprises a thermal envelope 28 used to maintain and minimize any loss of heat created by the heating elements 22.

As shown in FIG. 3, the return of the conveyor belt 30 is done in the furnace 20 also, in order to preheat and minimize energy losses. Preferably, even though it is not shown in FIGS. 2 to 5, the driver rollers 16 and the end rollers 18 of the conveyor belt 12 are surrounded by protective insulating guards, to decrease energy losses also. As illustrated in FIG. 3, the driver roller 16 is linked to a toothed wheel 17 with the help of a transmission chain 19.

The perlite or vermiculite falls from the feeding chute 26 onto the conveyor belt 14 and expands because of a thermal shock. The conveyor belt 14 carries the material to the exterior of the furnace 20, in the direction of the arrow shown on FIG. 3, where it is recuperated by another type of conveyor (not shown in the drawings), either a vibrating conveyor or a conveyor with a metallic belt, to be then transported to a storage location. Given the high temperature of the material at the exit of the furnace 20, it might be necessary to cool down the material with an induced air system, a water cooling system or any other similar system before being able to use the material, especially for horticultural processes.

The furnace 20 model shown in FIGS. 2 to 4 is equipped with an end roller 18 mounted, preferably, on an automatic tensioning system 60 for the metallic conveyor belt 14, to counter the thermal expansion of the belt, during the heating process in the furnace. As illustrated more particularly in FIG. 3, the automatic tensioning system 60 comprises a guideway 62 and preferable comprises a pneumatic piston.

Feeding of material into the furnace 20 is done through the feeding chute 26. The embodiment shown in FIGS. 2 to 4 does not show the chute feeding system 26, which could use a vibrating conveyor or any other apparatus. Preferably, the feeding system must allow a constant input of mineral into the furnace to ensure a constant energy consumption, since an increase in the feeding of minerals could result in incomplete baking or the reverse effect, if there is a decrease in the amount of material being fed. This effect could therefore modify the quality of the expanded product.

When the apparatus is activated for an expansion process, preferably the three following parameters are to be controlled:

the temperature of the furnace 20;

the speed of the conveyor belt 14; and

the flow of material.

The temperature of the furnace 20 can be controlled manually or by an automatic system depending on the operator's needs. The range of temperatures used in the furnace is sufficient for expanding perlite or vermiculite. The temperature can therefore be adapted as a function of the type of mineral being processed and the flow of material.

The speed of the conveyor belt 14 can also be modified manually or could be regulated automatically as a function of the flow of material, of its humidity and size, by an automated system controlled by a PLC (programmable logic controller) or a computer.

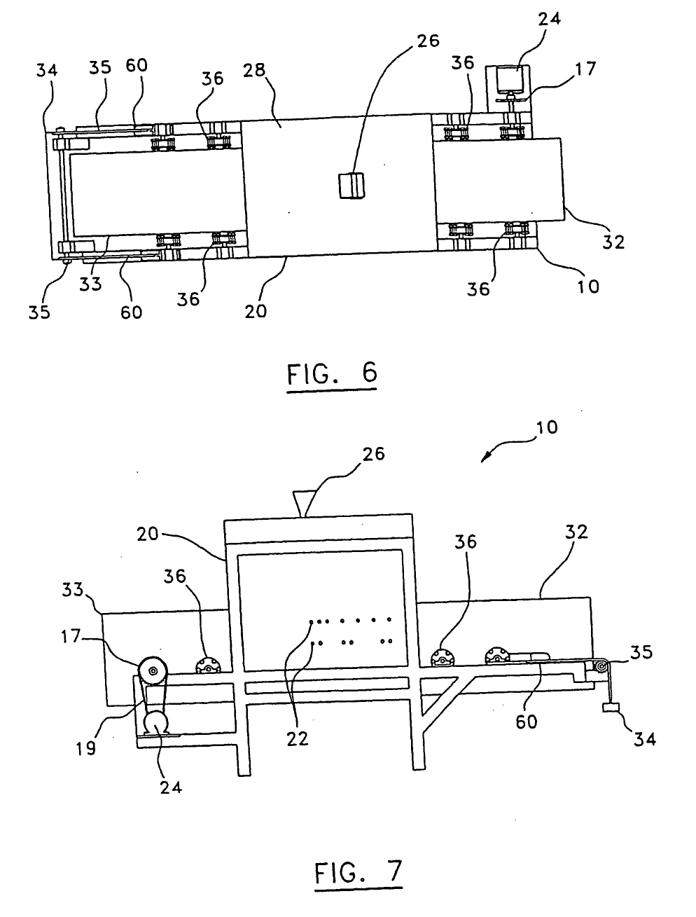

According to a second preferred embodiment shown in FIG. 6 to 8, in the expansion apparatus 10, the driver roller 16 and the end roller 18, as well as their shafts are made of materials resistant to high temperatures, preferably made with 330 stainless steel.

This embodiment is designed for large production speeds in which the conveyor belt 14 travels in the upper speed limits of its range.

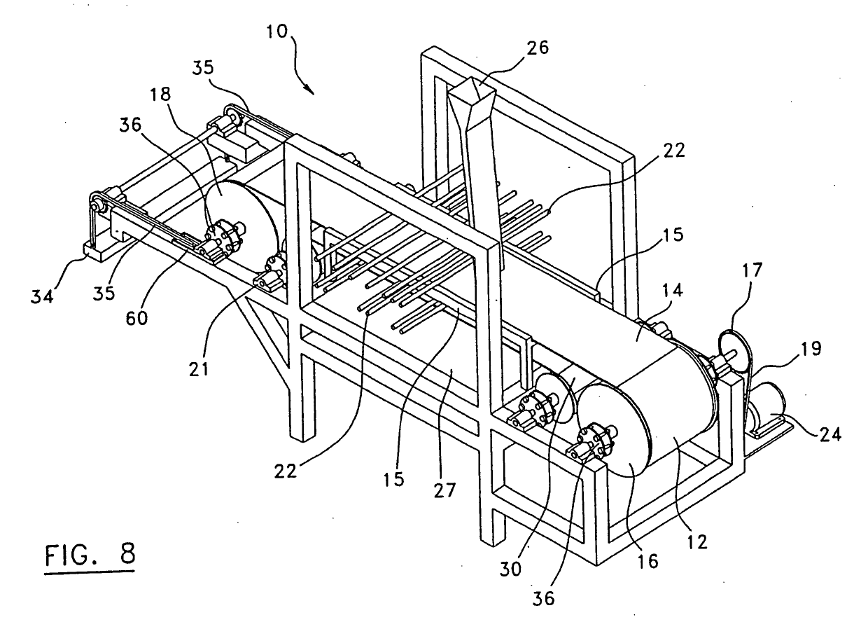

Moreover, the furnace 20 is equipped with insulated protective guards at the inlet 32 and the outlet 33, comprising an insulated layer, preferably made of Pyroblock™, added to the front and back of the furnace 20 to reduce heat losses due to exposure, on the outside of the furnace 20 of the driver rollers 16 and the end rollers 18, as well for certain sections of the conveyor belt 14. In this second preferred embodiment, the driver rolls 16 and the end rolls 18 are mounted on smooth bearings, preferably made of graphite. Shank couplings 36 are integrated in order to allow a better dissipation of heat between the shaft of the driver rollers 16 and the end rollers 18, and the smooth bearings 21. The furnace 20 shown in FIG. 8 is equipped with an end roller 18 mounted, preferably, on a system of counterweights and guides 34, equipped with a counterweight chain.

The expansion process of the present invention being done on a conveyor belt, it is possible to change the width of the belt, for example, and certain parameters of the expansion apparatus can also be modified to obtain a production capacity of about 50 lbs/hour, preferably between 50 lbs/hour and 200 lbs/hour.

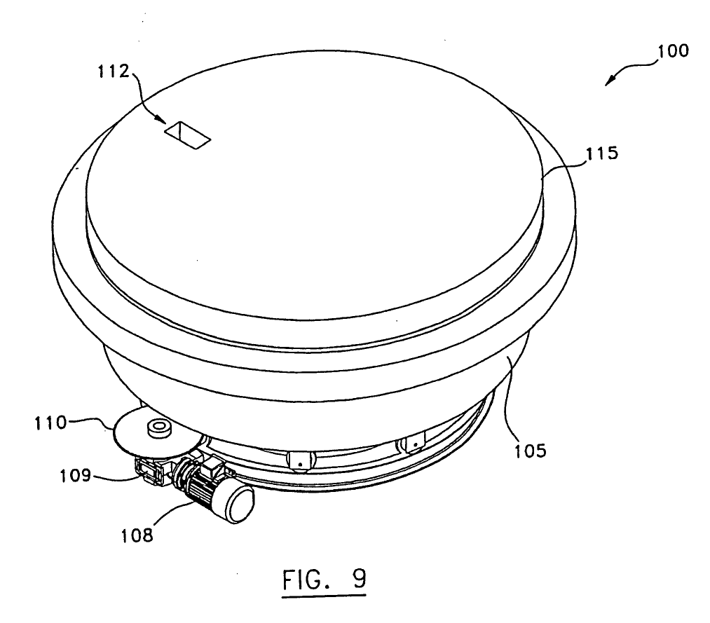

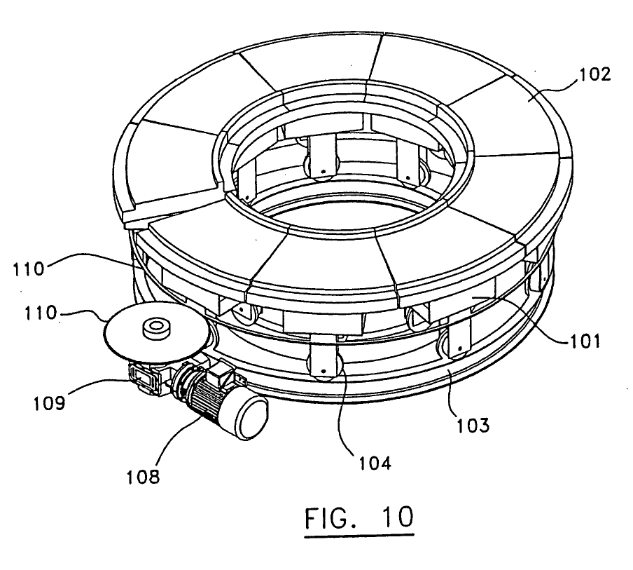

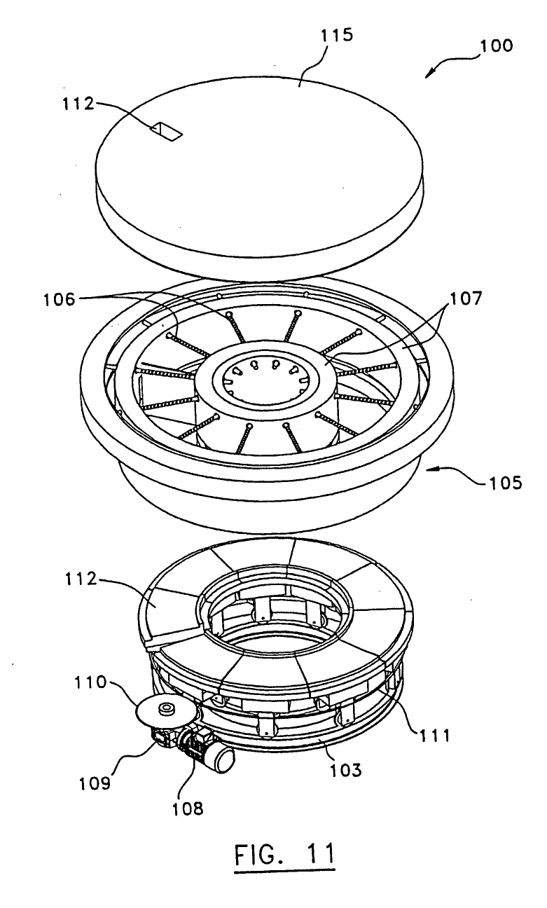

According to a third preferred embodiment shown in FIGS. 9 to 14, the expansion apparatus 100 comprises a rotary carrier 101 including a plate 102 made of refractory material mounted on rollers 104 and rail guides 103 inside a closed enclosure 105 on which a cover 115 is mounted. The closed enclosure 105 and the cover 115 are fixed while the rotary carrier 101 and the refractory plate 102 rotate around the point designated as the center of the apparatus. The refractory plate 102 is heated with electrical heating elements 106 (or any alternates source of energy such as natural gas or other furnace oils used to produce heat for the heating elements within a contained combustion chamber). As shown in FIGS. 11 to 13, the different sidewalls of the furnace 100 are made of insulating materials 107 such as refractory bricks and thermal wool.

The principle behind the functioning of the apparatus is described as follows. The rotary carrier 101 is driven on rail guides 103 by an electric motor 108. A power transmission system comprising a reducing gear box 109, a drive wheel pinion 110 and a chain 111 ensure the mechanical link between the electric motor 108 and the rotary carrier 101. While it turns, the rotary carrier 101 places the refractory plate 102 under the heating elements 106, to heat the plate to the necessary temperature for expansion of the material. The refractory plate 102 is designed to not let any material pass therethrough, while retaining as much heat as possible. The heating elements 106 are positioned in order to transmit the greatest amount of heat to the refractory plate 102 before material is deposited on the plates from a feeding chute 112, placed above the refractory plate 102. Although expansion of the material is done through a continuous rotation of the rotary plate, the process is better understood by observing a complete 3600 turn of the rotary plate.

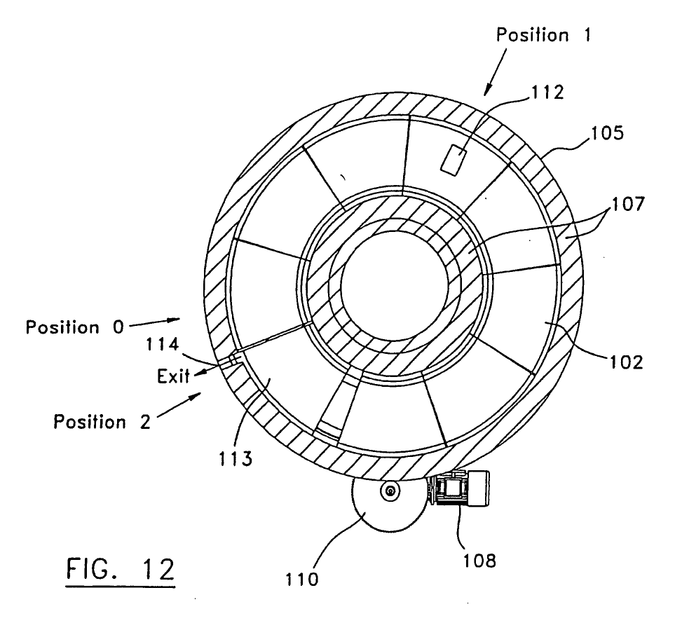

As shown in FIG. 12, at the initial 0 position, the refractory plate 102 is free of any material. From the 0 position to position 1, the refractory plate 102 is heated by the heating elements 106 to the required temperature for expansion of the mineral. (Note: in the case of use of combustibles like natural gas or other heating oils as sources of energy, a flame could be used to heat the refractory plate 102, without having the flame enter in contact with the expandable material) At position 1, the material is introduced by the feeding chute 112 and deposited on the refractory plate 102 as a uniform layer having a predetermined surface density. A thermal shock is created by the contact between the material and the refractory plate 102 at high temperature, and causes expansion of the material. In order to optimize expansion, the material is kept on the refractory plate 102 until reaching the position 3 before being recovered. A deflecting system 113 such as a scraper or a jet of air, allows removal of the expanded material towards an evacuation chute 114 located on the exterior diameter of the furnace. The evacuation chute 114 directs the material to the outside of the furnace 100 where it can be recovered with a transport system, such as a conveyor. Once the material is removed from the refractory plate 102, the plate returns to the area having the heating elements 106 located between position 0 and position 1 to be heated once again to the required temperature for expansion of the mineral to start the cycle once again.

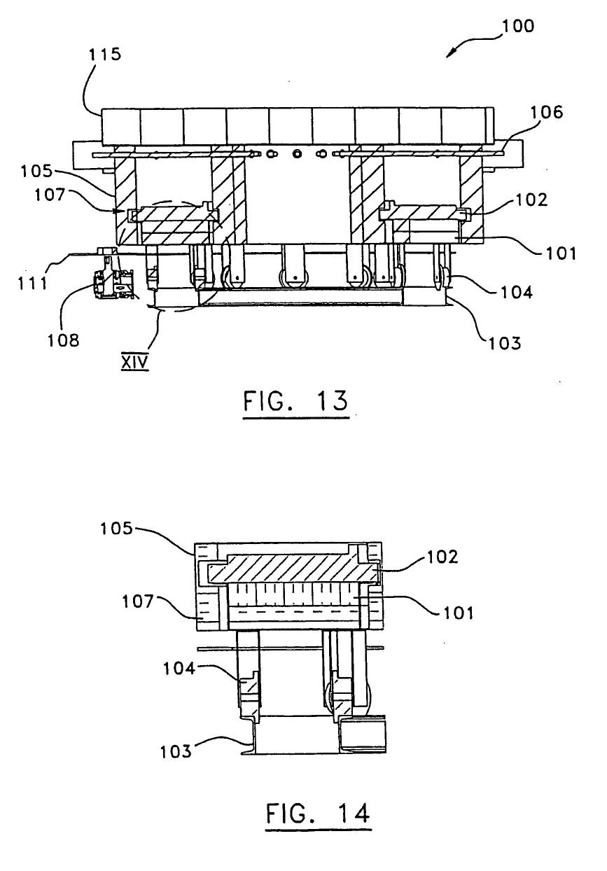

The heating elements 106 are placed ahead of the feeding chute 112 and allow an increase of the temperature of the refractory plate 102 to a temperature sufficient for creating a thermal shock when the material enters into contact with the refractory plate 102. As illustrated in FIG. 13, the rotary carrier 101 is completely enclosed inside the furnace 100 in order to minimize energy losses. The furnace 100 comprises a thermal envelope 107 used to minimize any loss of heat emitted by the heating elements 106.

As illustrated in FIG. 14, the geometry of the rotary carrier 101, of the interior walls and of the outside of the exterior enclosure 105 is designed such that these components create a baffle, which allows to minimize radiative heat losses from the heating elements 106, as well as convection of hot air towards the outside of the furnace 100. The use of a baffle is simple and efficient, but could be replaced by a more powerful system such as a water basin, a process known in the field of refractory furnaces.

Perlite or vermiculite falls from the feeding chute 112 onto the refractory plate 102 and expands due to thermal shock. Rotation of the rotary carrier 101 carries the material to the deflecting system 113. The deflecting system 113 allows removal of the expanded material to the outside of the furnace 100 in the direction of the exit arrow shown on FIG. 12. The material is recuperated on another type of conveyor (not shown in the drawings), a vibrating conveyor or a conveyor having a metallic conveyor belt, to be then brought to a storage location. Given the high temperature of the material at the outlet of the furnace 100 it might be necessary to cool down the material with an induced air system, a water cooling system or any other similar system before being able to use the final product, especially in horticultural processes.

The feeding of the furnace 100 is accomplished through the feeding chute 112. The model of the present invention shown in FIGS. 9 to 14 does not illustrate how the feeding chute system 112 could also be accomplished with a vibrating conveyor or any other apparatus. Preferably, the feeding system must allow a constant flow of material in order to ensure constant energy consumption, since an increase in the flow of material could result in incomplete baking or the reverse effect, if there is a decrease in the flow of material. This effect could therefore modify the quality of the expanded product.

When this apparatus is used in an expansion process, preferably the three following parameters must be controlled:

the temperature of the furnace 100;

the speed of the rotary carrier 101; and

the flow of material.

The temperature of the furnace 100 can be controlled manually or by an automated system depending on the needs of the operator. The range of temperatures in the furnace is sufficient to allow expansion of perlite and vermiculite. The temperature can therefore be adapted as a function of the type of material and flow.

The displacement speed of the rotary carrier 101 can also be modified manually or could possibly be regulated automatically as a function of the material flow, of the humidity and size of the material, by a PLC (Programmable Logic Controller) or computer automated system.

According the this third preferred embodiment shown in FIG. 9 to 14, the walls of the outside enclosure 105 as well as the refractory plate 102 and the main parts of the rotary plate 101 are made of refractory materials resistant to extremely high temperatures. As the only metallic mechanical components of the furnace 100 are the rollers 104, the rail guides 103 as well as the transmission system comprising the reducing gear box 109, the pinion drive wheel 110, the chain 111 and given that these two sets of components are located outside the furnace 100 at ambient temperature, the maximum baking temperature of the furnace 100 is not limited by the maximum operating temperatures of the steel and other metallic materials.

This preferred embodiment is designed to be used with large production speeds in which the rotary carrier 101 can rotate in its upper speed ranges.

The process and apparatus according to the present invention, as described above, presents several advantages. Firstly, since the combustion is not made with a burner, there is no formation of carbon deposits on part of the structure, nor production of combustion gases, as opposed to systems such as the one described in U.S. Pat. No. 4,579,525 where combustion gases enter directly into contact and mix with the expandable material. The system is therefore not dangerous for the environment.

Furthermore, with the fact that the mineral is deposited on the conveyor, it is not necessary for the furnace operator to balance the air flow of the said furnace as a function of the density of the material. Automation of the process can therefore be accomplished without human intervention.

Moreover, this technology being simple, the different components of the expansion apparatus do not have to be replaced due to abrasion caused by perlite, for example, which travels in the air flow, as observed in traditional expansion processes.

The present process presents the additional advantage of being adaptable to precise needs. The furnace can be built according to any desired capacity. Moreover, it is not necessary to have a deduster system or a pneumatic transport system for the expanded perlite or vermiculite. It must be noted that a pneumatic transport system can break the material into pieces, after expansion. This can represent up to a 20% increase in density. Also, the same furnace can be used either for perlite or vermiculate, without modification to the expansion apparatus components.

As opposed to the traditional processes used, the expanded material is not taken from the expansion apparatus with an air intake system to be then separated mechanically, which requires generally several thousands of cubic feet of air per minute. The air heated in this manner is lost to the exterior. In the present invention, the heat is more concentrated where it is required. In U.S. Pat. No. 4,579,525, attempts were made to concentrate the heat in proximity of the contact surface that heats the expandable material. However, the system disclosed in U.S. Pat. No. 4,579,525 allows hot combustion gases to enter directly into contact with the expandable material. Heat from the combustion is lost after expansion of the material since the hot combustion products are removed from the furnace, thus reducing efficiency of the system. In the present invention, all heat produced by the heating means is directed to heating the contact surface, which heats the expandable material through conduction and radiation. No combustion gases are allowed to traverse the contact surface and enter into contact with the material to be processed, thus improving the efficiency of the furnace, since the heated contact surfaces remain within the furnace and are not removed from the system.

Moreover, the process according to the present invention allows, in the case of perlite, to obtain a whiter perlite than what is obtained with known furnaces. The process also offers the following advantages:
obtaining a much greater automation;
obtaining lower maintenance costs;
requiring less capital investment;
generating a better energetic efficiency;
obtaining a constant expansion quality;
producing less dust or damage to material; and
providing a format of equipment adaptable to the desired production capacity.

Although the present invention has been explained hereinabove by way of preferred embodiments thereof, it should be understood that the invention is not limited to these precise embodiments and that various changes and modifications may be affected therein without departing from the scope of the invention.

1. A furnace for expanding volcanic rocks that expand when heated at a predetermined thermal shock temperature, the furnace being characterized in that it comprises:
a thermally insulated enclosure;
a conveyor for conveying the volcanic rocks within the enclosure, the conveyor having a contact surface made of a heat resistant material resistant to at least said pre-determined thermal shock temperature;
a heating system located inside the furnace for heating said contact surface to said predetermined thermal shock temperature;
feeding means for feeding the enclosure with the volcanic rocks to expand and for depositing said volcanic rocks on the contact surface;
removing means for removing the expanded volcanic rocks from the enclosure,
whereby, the volcanic rocks, at the touch of the contact surface, expands through thermal shock and produces the expanded volcanic rocks.

2. The furnace according to claim 1, characterized in that the feeding means comprises a feeding chute having an inlet outside the enclosure for receiving the volcanic rocks to expand and an outlet positioned in the enclosure above the conveyor to deposit said volcanic rocks on the contact surface.

3. The furnace according to claim 2, characterized in that the heating system comprises heating elements and a majority of said heating elements are mounted to heat the contact surface of the conveyor at locations along a trajectory of the conveyor upstream of the chute outlet.

4. The furnace according to claim 3, characterized in that the heating elements comprise electrical heating elements.

5. The furnace according to claim 1, wherein the conveyor comprises a rotary plate contained in the enclosure and the contact surface is a top face of said rotary plate.

6. The furnace according to claim 5, characterized in that said heat resistant material is selected from the group consisting of ceramics and metals.

7. The furnace according to claim 6, characterized in that said heat resistant material is ceramic.

8. The furnace according to claim 6, characterized in that said heat resistant material is steel.

9. The furnace according to claim 5, characterized in that the furnace further comprises rail guides and rollers adapted to travel along said rail guides, wherein the rotary plate is mounted on the rollers.

10. The furnace according to claim 1, characterized in that the enclosure comprises sidewalls covered with insulating material.

11. The furnace according to claim 10, characterized in that said insulating material is selected from the group consisting of refractory bricks and thermal wool.

12. The furnace according to claim 10, characterized in that the conveyor further comprises:
a motor and
a power transmission system transmitting motion of the motor to rotation of the rotary plate.

13. The furnace according to claim 12, characterized in that the power transmission system comprises:
a reducing gear box;
a drive wheel pinion driven by the gear box; and
a chain transmitting motion from the drive wheel pinion to the rotary plate.

14. The furnace according to claim 1, characterized in that the furnace further comprises an evacuation chute and the removing means is a scraper directing the expanded material towards the evacuation chute.

15. The furnace according to claim 1, characterized in that the furnace further comprises an evacuation chute and the removing means is a jet of air positioned to direct the expanded volcanic rocks towards the evacuation chute.

16. The furnace according to claim 1, characterized in that the furnace further comprises an outlet for the expanded volcanic rocks and a cooling system to reduce the temperature of the expanded volcanic rocks at the outlet.

17. The furnace according to claim 2, characterized in that the conveyor comprises:
a conveyor belt made of metal;
a driver roller driving the conveyor belt;
an end roller directing the conveyor belt back towards the driver roller; and
a motor driving the driver roller, and
in that the heating system comprises heating elements mounted to heat the contact surface of the conveyor at locations along a trajectory of the conveyor upstream of the chute outlet.

18. The furnace according to claim 17, characterized in that the conveyor further comprises a guideway preventing volcanic rocks from falling from the conveyor.

19. The furnace according to claim 17, characterized in that the furnace further comprises protective insulating guards surrounding the driver roller and the end roller.

20. The furnace according to claim 17, characterized in that the furnace further comprises an automatic tensioning device wherein the end roller is mounted on the automatic tensioning device.

21. The furnace according to claim 17, characterized in that the driver roller and the end roller are made of a second heat resistant material.

22. The furnace according to claim 21, characterized in that the second heat resistant material is 330 stainless steel.

23. The furnace according to claim 17, characterized in that the furnace comprises smooth graphite bearings on which the driver roller and the end roller are mounted.

24. The furnace according to claim 1, characterized in that the feeding means feeds the volcanic rocks at a predetermined rate.

25. The furnace according to claim 3, characterized in that the heating elements comprise contained combustion chambers.

26. The furnace according to claim 25, characterized in that the contained combustion chambers are fed with fuel selected from the group consisting of natural gas and heating oil.

27. The method for expanding volcanic rocks that expands when heated at a predetermined thermal shock temperature, said method comprising the steps of:
a) providing a thermally insulated enclosure;
b) conveying the volcanic rocks within the enclosure, the conveyor having a contact surface made of a heat resistant material resistant to at least said predetermined thermal shock temperature;
c) heating said contact surface to said predetermined thermal shock temperature;
d) depositing said volcanic rocks on the contact surface;
e) removing the expanded volcanic rocks from the enclosure, whereby, the volcanic rocks, at the touch of the contact surface, expands through thermal shock and produces the expanded material.

28. The method according to claim 27, characterized in that the volcanic rocks are selected from the group consisting of vermiculite and perlite.

29. The method according to claim 28, characterized in that the volcanic rocks are perlite.

30. The method according to claim 28, characterized in that the volcanic rocks are vermiculite.
